(19) United States
(12) Patent Application Publication
(10) Pub. No.: US 2018/0110190 A1
(43) Pub. Date: Apr. 26, 2018

(54) WORK VEHICLE GYROSCOPIC BOOM CONTROL SYSTEM AND METHOD

(71) Applicant: Deere & Company, Moline, IL (US)

(72) Inventors: John R. Mahrenholz, Peosta, IA (US); Calin Raszga, Asbury, IA (US); Daryl I. Rober, Asbury, IA (US)

(21) Appl. No.: 15/299,129

(22) Filed: Oct. 20, 2016

(51) Int. Cl. A01G 23/099; A01G 23/081

(52) U.S. Cl. CPC A01G 23/099; A01G 23/081

(57) ABSTRACT

A work vehicle gyroscopic boom assembly control system utilizes gyroscopically-measured angular velocity data to control boom movement. The work vehicle includes an operator interface, a boom assembly, a first gyroscope, and a controller. The boom assembly includes a first boom element coupled to a first actuator, which is controllable to rotate the first boom element about a first pivot joint. During operation of the work vehicle, the controller receives an operator request for boom assembly movement via the operator interface, converts the operator request to a target angular velocity of the first boom element, and selectively commands the first actuator to adjust rotation of the first boom element based, at least in part, on the target angular velocity and a current angular velocity of the first boom element sensed by the first gyroscope.

### CROSS-REFERENCE TO RELATED APPLICATION(S)

Not applicable.

### STATEMENT OF FEDERALLY SPONSORED RESEARCH OR DEVELOPMENT

Not applicable.

### FIELD OF THE DISCLOSURE

This disclosure relates generally to work vehicles and, more particularly, to feller bunchers and other work vehicles including gyroscopic boom assembly control systems, as well as to methods for controlling boom assembly movement utilizing gyroscopically-detected angular velocity data.

### BACKGROUND OF THE DISCLOSURE

A work vehicle may be equipped with an end effector, which is mounted to the vehicle chassis or frame by a boom assembly. In many instances, the boom assembly may be movable in multiple Degrees of Freedom (herein a “multi-DOF boom assembly”) to permit relatively complex manipulations of the end effector useful in performing tasks in forestry, construction, agriculture, and other industries. For example, in the case of a feller buncher of the type utilized to harvest trees, a felling head may be mounted to the vehicle frame by a boom assembly movable in four degrees of freedom. The boom assembly may include a hoist boom pivotally joined to the vehicle frame, a stick boom pivotally joined to the hoist boom opposite the vehicle frame, and a wrist adapter pivotally joined to the stick boom opposite the hoist boom. Additionally, the wrist adapter may be rotatably coupled to the felling head in a manner permitting rotation of the felling head in a plane orthogonal to the vertical plane in which the stick boom and hoist boom move. An operator may control boom assembly movement utilizing operator controls, such as a bidirectional joystick, located within the operator cabin of the feller buncher. Considerable skill and practice is typically required before an operator is able to control a multi-DOF boom assembly in a highly precise and efficient manner without which certain inefficiencies, prolonged timetables, and user-associated costs may be realized.

### SUMMARY OF THE DISCLOSURE

Embodiments of a work vehicle including a gyroscopic boom assembly control system are provided. In one embodiment, the work vehicle includes an operator interface, a boom assembly, a first gyroscope, and a controller. The boom assembly includes, in turn, a first boom element (e.g., a hoist boom or a stick boom) rotatable about a pivot joint. A first actuator (e.g., a hydraulic cylinder, a flow control valve, and an associated valve controller) is coupled to the first boom element and is controllable to rotate the first boom element about the first pivot joint. During operation of the work vehicle, the controller receives an operator input or an “operator request” for boom assembly movement via the operator interface, converts the operator request to a target angular velocity of the first boom element, and selectively commands the first actuator to adjust rotation of the first boom element based, at least in part, on a differential the target angular velocity and a current angular velocity of the first boom element sensed by the first gyroscope.

In another embodiment, the work vehicle includes a vehicle frame and an end effector, such as a felling head. A boom assembly mounts the end effector to the vehicle frame. The boom assembly includes a hoist boom, which is joined to the vehicle frame at a first pivot joint, and a stick boom, which is coupled between the vehicle frame and the end effector and which is joined to the hoist boom substantially opposite the vehicle frame at a second pivot joint. A first actuator is coupled to the hoist boom and is controllable to rotate the hoist boom about the first pivot joint, while a second actuator is coupled to the stick boom and is controllable to rotate the stick boom about the second pivot joint. First and second gyroscopes are mounted to the hoist boom and the stick boom, respectively. A controller is operably coupled to the first and second actuators and to the first and second gyroscopes. The controller is configured to command the first and second actuators to selectively rotate the hoist boom and the stick boom based, in part, on angular velocity data provided by the first and second gyroscopes.

Methods for controlling the movement of a work vehicle boom assembly are further provided. In one group of embodiments, the control method includes the steps or processes of receiving operator requests for movement of a boom assembly, converting the operator requests to target angular velocities for multiple boom elements ((n)ω_{TARGET}) included in the boom assembly, and transmitting command signals to actuators further included in the boom assembly to rotate the multiple boom elements in accordance with (n)ω_{TARGET}. After transmitting the command signals, current angular velocities of the multiple boom elements ((n)ω_{CURRENT}) are measured utilizing gyroscopes mounted to the boom assembly. Error differentials between (n)ω_{TARGET} and (n)ω_{CURRENT} are then calculated, and further command signals are issued to the actuators to reduce any error differentials exceeding one or more maximum acceptable thresholds. In certain embodiments, the operator requests may be received as requests for linear movement of an end effector mounted to the boom assembly, and the operator requests for linear end effector movement may be converted to the target angular velocities for the multiple boom elements. In such embodiments, the current angular orientations ((n)α_{CURRENT}) of the multiple boom elements may be estimated based, at least in part, on acceleration data provided by one or more accelerometers mounted to the boom assembly. The operator requests for linear end effector movement may then be converted to target angular velocities for the multiple boom elements utilizing (n)α_{CURRENT}. Finally, in certain implementations, the step or process of estimating may entail approximating the position of a stick pin, which pivotally joins the boom assembly to a felling head, relative to a frame of a work vehicle to which the boom assembly is mounted.

The details of one or more embodiments are set forth in the accompanying drawings and the description below. Other features and advantages will become apparent from the description, the drawings, and the claims.

### BRIEF DESCRIPTION OF THE DRAWINGS

At least one example of the present disclosure will hereinafter be described in conjunction with the following figures, wherein like numerals denote like elements, and:

FIG. 1 is a perspective view of a work vehicle (here, a tracked feller buncher) including a boom assembly and into which a gyroscopic boom assembly control system is incorporated, as illustrated in accordance with an example embodiment of the present disclosure;

FIG. 2 is a side view of the tracked feller buncher shown in FIG. 1 further illustrating example locations at which gyroscopes and other sensors included within gyroscopic boom assembly control system may be mounted to the feller buncher;

FIG. 3 is an isometric view of a joystick, which may be located within an operator cabin of the feller buncher shown in FIGS. 1 and 2 and utilized to receive operator requests for movement of the boom assembly in an example embodiment;

FIGS. 4 and 5 are schematics illustrating various manners in which the boom assembly of the feller buncher may be moved to allow movement of the end effector along linear (X-Y) axes with respect to different frames of reference;

FIG. 6 is a flowchart setting-forth a method for controlling boom assembly movement utilizing gyroscopically-detected angular velocity data, which may be carried-out by the gyroscopic boom assembly control system shown in FIG. 1 in an example embodiment of the present disclosure; and

FIG. 7 is a gyroscopic feedback control algorithm, which may be performed as part of the method set-forth in FIG. 6 and which is illustrated with a further example embodiment of the present disclosure.

### DETAILED DESCRIPTION

The following describes one or more example embodiments of systems and methods for controlling the movement of a boom assembly, and thus the movement of an end effector support by the boom assembly, utilizing angular velocity data provided by a gyroscopic sensor array. Various modifications to the example embodiment(s) described below may be contemplated by one of skill in the art.

Embodiments of the gyroscopic boom assembly control system and method utilize an array of gyroscopes to monitor the respective angular velocities of multiple boom elements, such as the hoist boom and the stick boom of a feller buncher or other work vehicle. Gyroscopes may also be mounted to and provide angular velocity data pertaining to an end effector (e.g., a felling head) supported by the boom assembly and/or to the vehicle frame itself. The gyroscopes may be Microelectromechanical Systems (MEMS) gyroscopes, which, in at least some implementations, are packaged with other MEMS sensors (e.g., MEMS accelerometers) as Inertial Measurement Units (IMUs). Other sensors may also be integrated into the boom assembly, if desired, such as potentiometers (for measuring joint angle or cylinder stroke) or linear variable differential transducers (for measuring cylinder stroke); however, the usage of such legacy sensors may be unnecessary in embodiments and, thus, such sensors may be eliminated or at least reduced in number to bring about cost and weight savings as compared to other conventional boom assembly control systems.

During operation, the gyroscopic boom assembly control system receives operator requests specifying desired movements of the boom elements. In certain embodiments, the operator requests may directly specify rotational movement (direction and angular speed) of one or more boom elements. In other embodiments, the operator requests may specify a desired movement of the end effector supported by the boom assembly, such as a desired linear movement of the end effector. In either case, the boom assembly control system subsequently converts the operator requests to target angular velocities of boom elements. The boom assembly control system then generates and transmits appropriate command signals to actuators included within the boom assembly to implement the target angular velocities. In many embodiments, the actuators included within the boom assembly will include hydraulic cylinders, valve controllers, and flow control valves, which regulate the flow of hydraulic fluid to the hydraulic cylinders to control cylinder stroke. For this reason, the boom assembly actuators will be primarily described below as hydraulic cylinders and the issued commands (as transmitted to the valve controllers) as flow rate adjustments. It will be understood, however, that alternative embodiments of the gyroscopic boom assembly control system may control the movement of boom assemblies containing other types of actuators, as well, including pneumatic and electromagnetic actuators.

In certain embodiments, the angular velocity measurements gathered by the gyroscope array may be considered prior to issuing commands to the boom assembly actuators utilizing a feed-forward control architecture. In this regard, real time or near real time data may be gathered from the gyroscopes describing the current angular velocities of the boom elements, error differentials between the current angular velocities and the target angular velocities may be calculated, and any error differentials may then be considered when determining the commands (e.g., flow rate adjustments) appropriately transmitted to the boom assembly actuators. Additionally or alternatively, the angular velocity measurements supplied by the gyroscopes may be considered after issuance of the actuator commands in evaluating and reducing or eliminating any calculated error differentials between the target angular velocities and the measured angular velocities of the boom elements. For example, one or more error differentials may be calculated, compared to static or dynamic acceptable thresholds, and additional actuator commands (e.g., flow rate adjustments) may then be determined and issued if one or more of the error differentials exceed the acceptable thresholds. This corrective feedback process may be performed iteratively until new operator commands for boom assembly movement are received to provide highly stable and “smooth” control of the boom assembly and the end effector supported thereby.

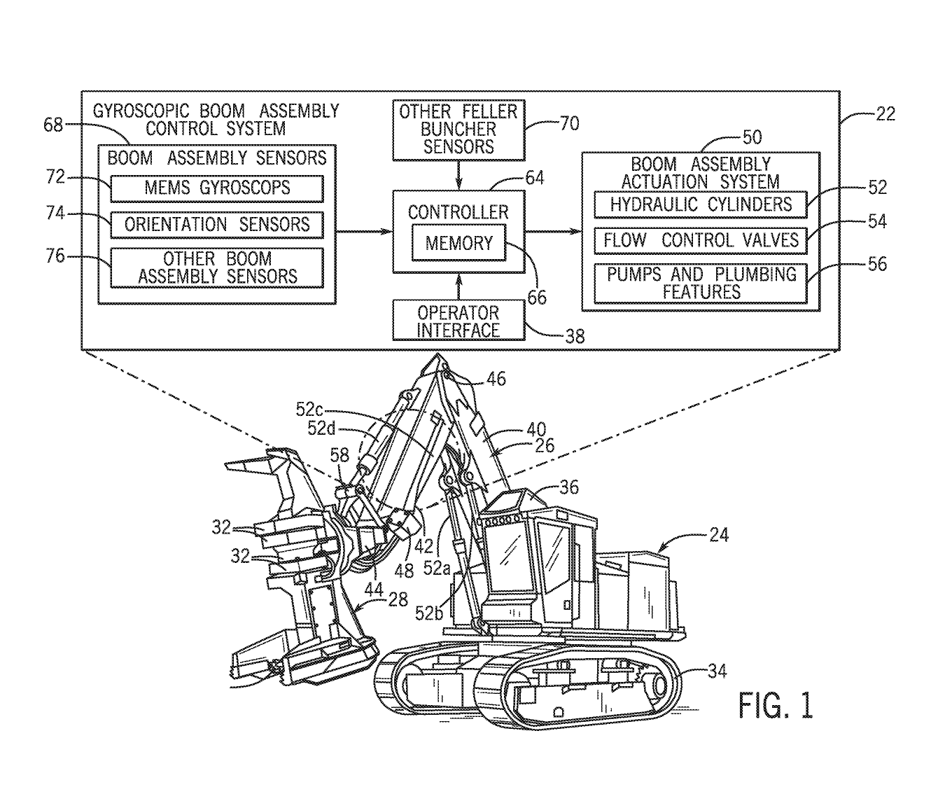

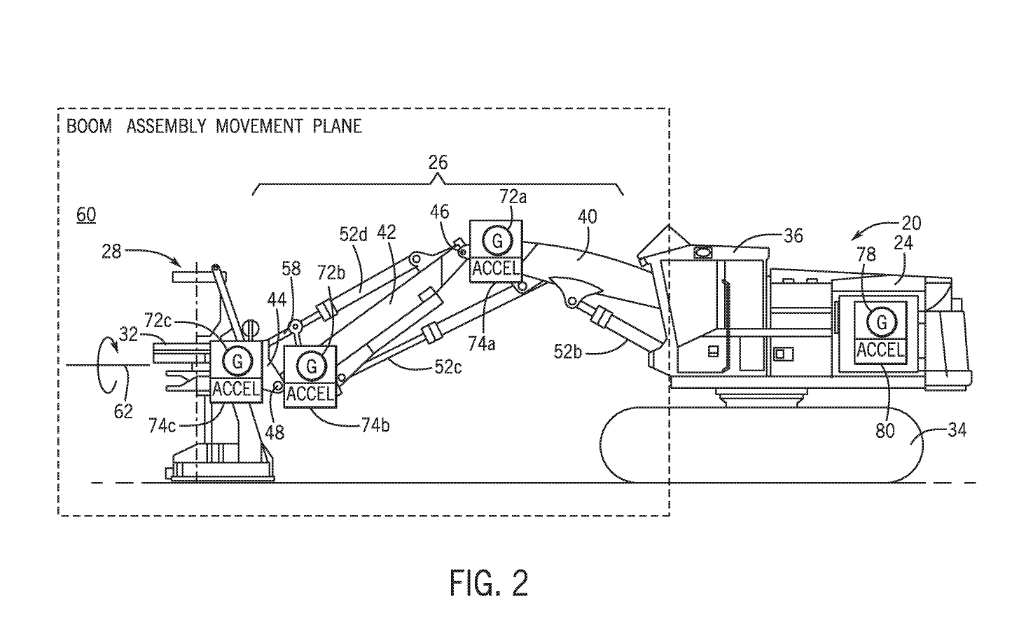

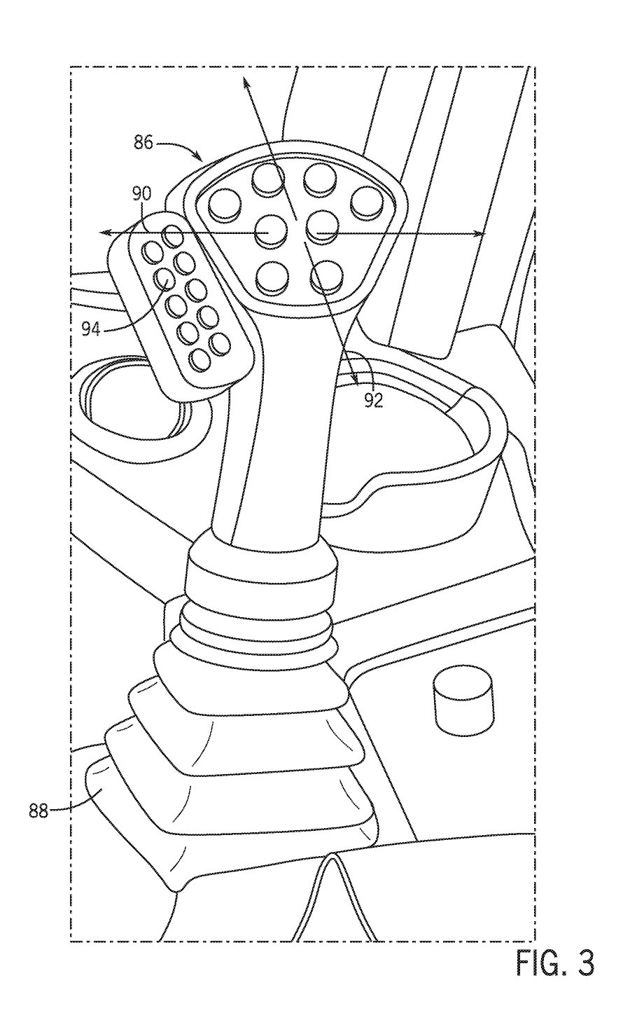

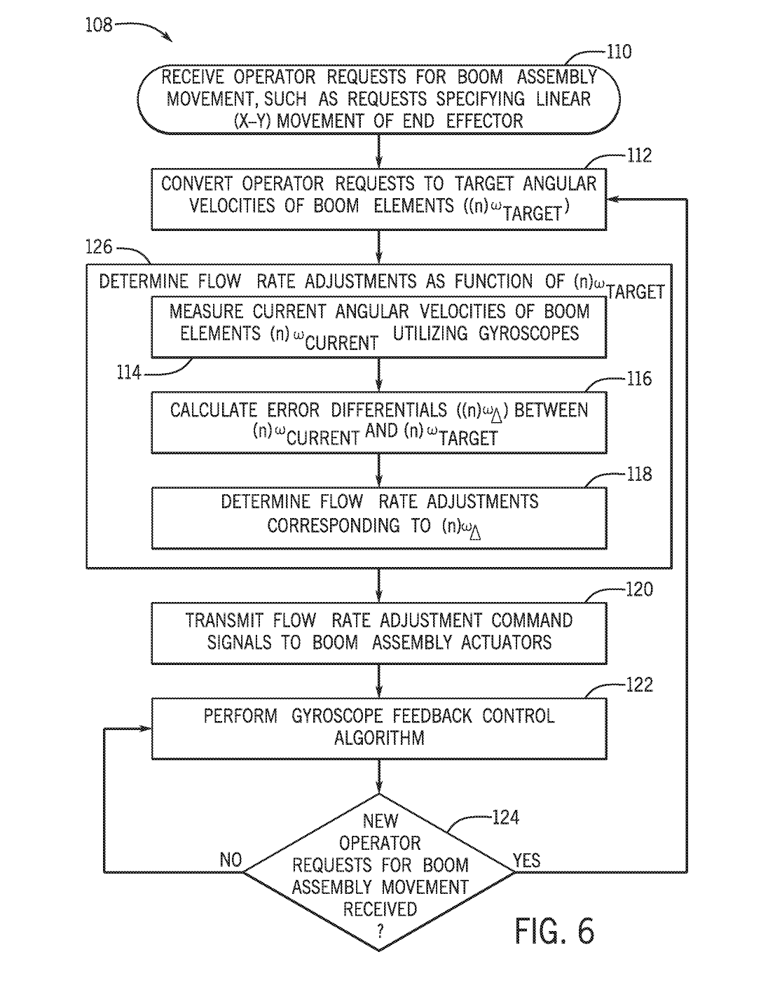

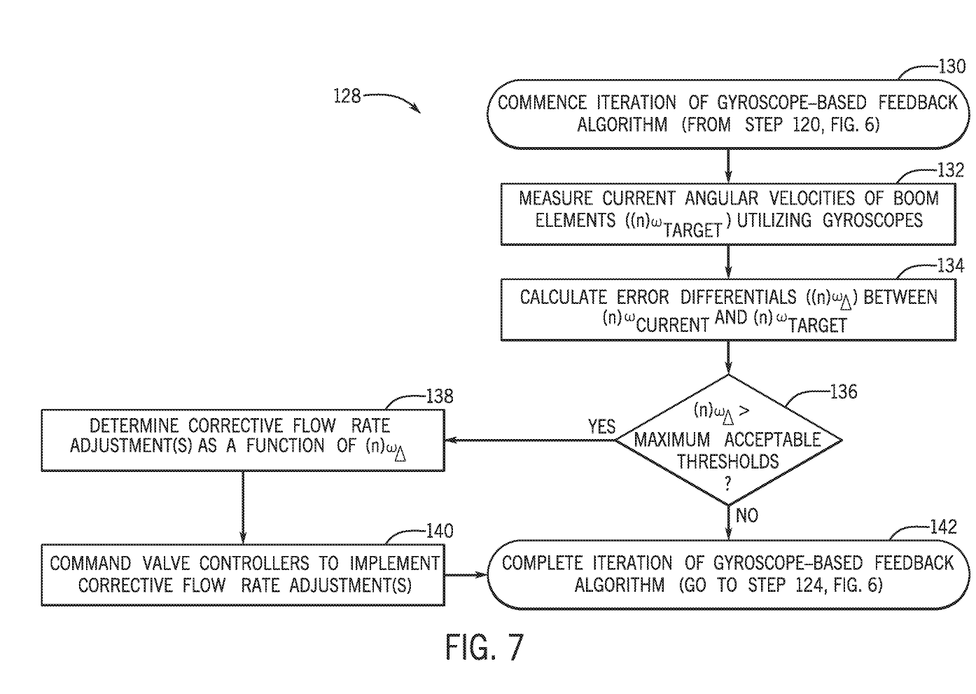

Additional description of manners in which the gyroscopically-detected angular velocity data may be utilized to provide improved control of boom assembly and end effector movement is provided below in conjunction with FIGS. 6 and 7. First, however, an example work vehicle into which embodiments of the gyroscopic boom assembly control system may be incorporated is described below in conjunction with FIGS. 1 and 2; and description of manners in which operator requests for boom assembly movement may be received as requests specifying desired linear movement of an end effector is provided below in conjunction with FIGS. 3-5.

Example embodiments of a gyroscopic boom assembly control system will now be described in greater detail. To provide an illustrative context in which embodiments of the gyroscopic boom assembly control system may be better understood, the following describes the example control system primarily in conjunction with a particular type of work vehicle, namely, a tracked feller buncher including a hydraulically-actuated multi-DOF boom assembly supporting a felling head (shown in FIGS. 1, 2, 4, and 5). The following description notwithstanding, it will be appreciated that the gyroscopic boom assembly control system may be integrated into other types of boom assemblies carried by various different work vehicles in further embodiments. Furthermore, the gyroscopic boom assembly control system may be utilized in conjunction with boom assemblies supporting other types of end effectors and into which other non-hydraulic (e.g., electric or pneumatic) actuation systems are incorporated. As a specific alternative example, embodiments of the gyroscopic boom assembly control system may also be well-suited for usage in controlling a multi-DOF boom assembly, which is mounted to the frame of an excavator and which supports a bucket, grapple, or other end effector.

FIG. 1 is a perspective view of a feller buncher 20 including a gyroscopic boom assembly control system 22 (schematically shown), as illustrated in accordance with an example embodiment of the present disclosure. Feller buncher 20 includes a vehicle frame 24, a multi-DOF boom assembly 26, and an end effector in the form of a felling head 28. The multi-DOF boom assembly 26 mounts the felling head 28 to the vehicle frame 24 and permits movement of the felling head 28 in multiple (e.g., four) degrees of freedom. The felling head 28 is utilized to harvest standing trees and to transfer cut trees. Accordingly, the felling head 28 carries a saw disc 30 for cutting trees, as well as clasping arms 32 for securing cut and uncut trees to the felling head 28.

The vehicle frame 24 is supported by a tracked undercarriage 34 and may be rotatable relative to thereto about a substantially vertical axis. Additionally, the vehicle frame 24 may be able to tilt along fore-aft and lateral axes. The vehicle frame 24 includes an operator cabin 36 in which an operator interface 38 is located (schematically illustrated as included in the gyroscopic boom assembly control system 22 in FIG. 1). The operator interface 38 may include any number and type of input devices suitable for enabling an operator seated within the operator cabin 36 to control the movements of the multi-DOF boom assembly 26 and the various other functions of the feller buncher 20. In this regard, the operator interface 38 may include different combinations of buttons, switches, dials, joystick devices, alphanumeric input devices, graphical user interfaces and associated pointer devices, and the like. An example of a bidirectional joystick that may be included within the operator interface 38 and utilized, possibly in conjunction with other input devices, to control the movement of the multi-DOF boom assembly 26 is described below in conjunction with FIG. 3.

Turning now to the example boom assembly 26, the multi-DOF boom assembly 26 includes the following boom elements as primary mechanical links or load-bearing structures: a hoist boom 40, a stick boom 42, and a wrist adapter 44. A first end portion of the hoist boom 40 is pivotally mounted to the vehicle frame 24 at a first pivot joint (hidden from view in FIG. 1). A second, opposing end portion of the hoist boom 40 is pivotally joined to a first end portion of the stick boom 42 at a second pivot joint 46. Finally, a second, opposing end portion of the stick boom 42 is pivotally joined to the wrist adapter 44 at a third pin joint 46. The third pin joint 48 is also referred to as the “stick pin 48” herein. In certain embodiments of the below-described gyroscopic boom assembly control method, it may be useful to determine the spatial position of the stick pin 48 when converting operator requests for boom assembly movement to target angular velocities of one or more of the boom elements (e.g., the hoist boom 40 and the stick boom 42), as described more fully below in conjunction with FIGS. 6 and 7. In further embodiments, the multi-DOF boom assembly 26 may include a different number of boom elements, which may be movably joined in various different manners permitting controlled manipulation of the felling head 28 (or other end effector) relative to the vehicle frame 24.

The feller buncher 20 further includes a boom assembly actuation system 50, as schematically depicted in FIG. 1 as part of the gyroscopic boom assembly control system 22. The boom assembly actuation system 50 may assume any form and may include any number and type of components suitable for moving the multi-DOF boom assembly 26 (and the felling head 28) in accordance with operator requests received via operator interface 38 or as otherwise desired. In the illustrated example, the boom assembly actuation system 50 is an electro-hydraulic system including a plurality of hydraulic cylinders 52, associated flow control vales 54, and associated plumbing features (e.g., conduits, filters, and the like) and pump(s) 56. As indicated in the lower portion of FIG. 1, the hydraulic cylinders 52 may include a total of four hydraulic cylinders 52(a)-(d), which are integrated into the multi-DOF boom assembly 26 in a distributed fashion. The following description notwithstanding, the boom assembly 26 may include other types of non-hydraulic boom assembly actuation systems in further embodiments, such as a pneumatic or electromagnetic actuation system.

With continued reference to FIG. 1, two hydraulic cylinders 52(a)-(b) are positioned between the vehicle frame 24 and the hoist boom 40. When stroked in unison, the two hydraulic cylinders 52(a)-(b) rotate the hoist boom 40 about the first pivot joint to raise or lower the boom assembly 26 and the felling head 28. The two hydraulic cylinders 52(a)-(b) are thus commonly referred to as “hoist cylinders.” A third hydraulic cylinder 52(c) is positioned between the hoist boom 40 and the stick boom 42. The third hydraulic cylinder 52(c), when stroked, rotates the stick boom 42 about the second pivot joint 46. The third hydraulic cylinder 52(c) is thus commonly referred to as the “stick cylinder.” Lastly, the fourth hydraulic cylinder 52(d) is mounted between the stick boom 42 and a pivoting linkage 58, which is, in turn, joined to the wrist adapter 44. Extension or retraction of the fourth hydraulic cylinder 52(d) thus results in pivoting movement of the wrist adapter 44 about the stick pin 48. Accordingly, the fourth hydraulic cylinder 52(d) is commonly referred to as the “tilt cylinder.”

By virtue of the above-described structural arrangement, the hoist boom 40, the stick boom 42, and the wrist adapter 44 move in a common plane. This plane is identified in FIG. 2 as the “boom assembly movement plane 60.” The multi-DOF boom assembly 26 may also include other actuators for moving the felling head 28 relative to the vehicle frame 24 within, outside of, or through the primary boom assembly movement plane 60. For example, the wrist adapter 44 may include an actuator (e.g., a rotary motor) for rotating the felling head 28 within a plane that is substantially orthogonal to the primary boom assembly movement plane 60. This is indicated in FIG. 2 wherein graphic 62 represents the wrist adapter axis about which the felling head 28 may rotate with respect to the wrist adapter 44.

In the example embodiment shown in FIGS. 1 and 2, and referring specifically to FIG. 1, the gyroscopic boom assembly control system 22 further includes a controller 64, a memory 66, a number of boom assembly sensors 68, and other feller buncher sensors 70. The “other” feller buncher sensors 70 include those sensors that are not incorporated into the multi-DOF boom assembly 26 itself, but monitor parameters that pertaining to the operation of boom assembly 26 or, more generally, the feller buncher 20. The other feller buncher sensors 70 may include, for example, sensors mounted to the felling head 28 for monitoring the rotational speed of the saw disc 30, for measuring the proximity of objects to the felling head 28, or the like. Additionally or alternatively, the other feller buncher sensors 70 may include sensors integrated into the vehicle frame 24 for monitoring hydraulic pressures, environmental conditions, motor speeds, and other operational characteristics of the feller buncher 20.

The boom assembly sensors 68 are sensors that directly monitor parameters pertaining to the multi-DOF boom assembly 26. In the illustrated example, the boom assembly sensors 68 include a number of MEMS gyroscopes 72, a number of orientation sensors 74, and other boom assembly sensors 76. The number and type of MEMS gyroscopes 72 included within the gyroscopic boom assembly control system 22 will vary amongst embodiments, as will the locations at which the MEMS gyroscopes 72 are mounted to the boom elements. By way of example only, and as indicated in FIG. 2, the MEMS gyroscopes 72 may include three MEMS gyroscopes 72(a)-(c), which are mounted to the boom assembly 26 at different locations. The first MEMS gyroscope 72(a) may be mounted to the hoist boom 40 for monitoring the angular velocity of the hoist boom 40, as taken about the first pivot joint. In one embodiment, the first MEMS gyroscope 72(a) is a single axis or multi-axis gyroscope having at least one sense axis oriented substantially parallel to the rotational axis of the first pivot joint (that is, the axis about which the hoist boom 40 pivots as the hoist cylinders 52(a)-(b) extend or retract). Additionally, as indicated in FIG. 2, the first MEMS gyroscope 72(a) may be mounted to the end portion of the hoist boom 40 furthest from the first pivot joint and, perhaps, substantially adjacent the second pivot joint 46. In this manner, the distance traveled by the first MEMS gyroscope 72(a) per degree of rotation of the hoist boom 40 about the first pivot joint is maximized to enhance the sensitivity and accuracy of the MEMS gyroscope 72(a).

As further indicated in FIG. 2, the second MEMS gyroscope 72(b) may be mounted to the stick boom 42 at a location suitable for monitoring the angular velocity of the stick boom 42 when rotated about the second pivot joint 46. For example, the second MEMS gyroscope 72(b) may be mounted to the end portion of the stick boom 42 substantially opposite the second pivot joint 46 (that is, the stick boom end portion pivotally joined to the wrist adapter 44) to maximize the distance traveled by the MEMS gyroscope 72(b) per degree of rotation of the stick boom 42 about the pivot joint 46. Finally, the third MEMS gyroscope 72(c) may be mounted to the wrist adapter 44 (or, alternatively, the felling head 28) for monitoring the angular velocity of the wrist adapter 44, as taken about the stick pin 48. The second and third MEMS gyroscopes 72(b)-(c) may be single axis or multi-axis gyroscopes. In certain implementations, the MEMS gyroscopes 72(b)-(c) may each have at least one sense axis oriented substantially orthogonal to the boom assembly movement plane 60 and, thus, substantially parallel to the respective rotational axes of the second pivot joint 46 and the stick pin 48.

If desired, additional MEMS gyroscopes may be incorporated into the feller buncher 20 at other locations spatially remote from the boom assembly 26. For example, as further schematically indicated in FIG. 2, a fourth MEMS gyroscope 78 may be mounted to the vehicle frame 24. When provided, the fourth frame-mounted MEMS gyroscope 78 may be a three axis gyroscope capable of monitoring the angular velocity of the vehicle frame 24 about three orthogonal axes. Similarly, and as briefly noted above, a three axis gyroscope may also be mounted to the felling head 28 in further embodiments of the feller buncher 20 to monitor the angular velocities of the felling head 28 as the boom assembly 26 moves within the primary boom assembly movement plane 60 and as the felling head 28 is rotated about the wrist adapter axis 62.

The orientation sensors 74 included within the gyroscopic boom assembly control system 22 (FIG. 1) may assume any form suitable for determining or approximating the respective orientations of one or more of the boom elements, particularly the hoist boom 40 and the stick boom 42. By approximating the orientations of the hoist boom 40 and the stick boom 42, the spatial position of the stick pin 48 relative to the vehicle frame 24 may be determined, which may then be considered in determining the appropriate command signals or “flow rate adjustments” to transmit to the flow control valves 54 (FIG. 1) during performance of the below-described gyroscopic boom control method. In certain cases, the orientation sensors 74 may include sensors for monitoring the stroke or length of the hydraulic cylinders 52(a)-(d). Sensors suitable for this purpose include potentiometers and linear variable differential transformers. In other embodiments, the orientation sensors 74 may include sensors, for monitoring the joint angle at the first and second rotational joints such as potentiometers, rotary encoders, rotary variable differential transformers, and the like. This notwithstanding, it may be particularly advantageous from cost and design perspectives to utilize MEMS sensors as orientation sensors 74. For example, as further indicated in FIG. 2, a number of MEMS accelerometers 74(a)-(c) may be integrated into the boom assembly 26 and utilized to determine the orientation of the hoist boom 40, the stick boom 42, and/or the wrist adapter 44, as described more fully below.

When provided, the MEMS accelerometers 74(a)-(c) may measure the acceleration of the boom elements (e.g., the hoist boom 40, the stick boom 42, and/or the wrist adapter 44) along a single axis or multiple axes. In one embodiment, the MEMS accelerometers 74(a)-(c) are sensitive along at least two axes, which are oriented to extend substantially within the boom assembly movement plane 60. For example, first and second MEMS accelerometers 74(a)-(b) may monitor the acceleration of the hoist boom 40 and the stick boom 42, respectively, along at least two axes extending within the boom assembly movement plane 60. The third MEMS accelerometer 74(c) may monitor acceleration of the felling head 28 about three orthogonal axes to accommodate rotational displacement of the felling head 28 about the wrist adapter axis 62. Finally, if desired, additional MEMS accelerometers 80 may also be mounted to the felling head 28 and/or to the vehicle frame 24.

In embodiments of the feller buncher 20, the MEMS gyroscopes 72(a)-(c) may be packaged with the MEMS accelerometers 74(a)-(c), and possibly additional MEMS sensors, as IMUs. For example, as graphically indicated in FIG. 2, the MEMS gyroscopes 72(a)-(c) and MEMS accelerometers 74(a)-(c) may be packaged as a plurality of IMUs 72, 74(a)-(c), which are mounted to the boom assembly 26 at selected locations. In certain implementations, the IMUs 72, 74(a)-(c) may also contain other MEMS sensors, such as single axis or multi-axis magnetometers. Similarly, the frame-mounted MEMS gyroscope 78 and the frame-mounted MEMS accelerometer 80 may also be packaged as an IMU 78, 80, which may or may not include a magnetometer. Finally, the other boom assembly sensors 76 generically illustrated in FIG. 1 may include various different sensors 76 for monitoring other parameters pertaining to the boom assembly 26 beyond those mentioned above, such as hydraulic pressures and/or wear rates of the components of the boom assembly 26.

During operation of the feller buncher 20, the controller 64 of the gyroscopic boom assembly control system 22 receives signals from the operator interface 38, the boom assembly sensors 68, and the other feller buncher sensors 70. The controller 64 then processes such incoming signals and transmits command signals (e.g. flow rate adjustments) to the flow control valves 54 to control the stroke rate and direction of the hydraulic cylinders 52 and, therefore, the movement of the boom assembly 26. While represented as a single block in FIG. 1, the controller 64 may include any number of processing devices, which may be distributed throughout the feller buncher 20 and interconnected utilizing different communication protocols and memory architectures. In this regard, the controller 64 may include or assume the form of any electronic device, subsystem, or combination of devices suitable for performing the processing and control functions described herein. The controller 64 may be implemented utilizing any suitable number of individual microprocessors, memories, power supplies, storage devices, interface cards, and other standard components known in the art. Additionally, the controller 64 may include or cooperate with any number of software programs or instructions designed to carry-out various methods, process tasks, calculations, and control functions described herein. The signals received from the foregoing components may be transmitted over any combination of wired or wireless connections. In many cases, the foregoing components will communicate over a vehicular Controller Area Network (CAN) bus permitting bidirectional signal communication with the controller 64. Generally, then, the individual elements and components of the logic control architecture of the feller buncher 20 may be implemented in a distributed manner using any number of physically-distinct and operatively-interconnected pieces of hardware or equipment.

The controller 64 may further include or function in conjunction with a memory containing any number of volatile and/or non-volatile memory elements. The memory will typically include a central processing unit register, a number of temporary storage areas, and a number of permanent storage areas that store the data and programming required for operation of the controller 64. Such memory elements are collectively identified as a block entitled “memory 66” in the schematic of FIG. 1.

The controller 64 of the gyroscopic boom assembly control system 22 (FIG. 1) may determine target angular velocities of the hoist boom 40, the stick boom 42, and the wrist adapter 44 (collectively “the boom elements 40, 42, 44”) from operator requests received via the operator interface 38 (FIG. 1). In certain embodiments, the operator requests may directly specify angular velocities at which one or more of the boom elements 40, 42, 44 are desirably rotated. For example, an operator may move a joystick included within the operator interface 38 along a first axis to provide an operator request that a first boom element (e.g., the hoist boom 40) is desirably rotated in a first direction (indicated by the direction of joystick movement along the first axis) at a certain angular speed (indicated by displacement of the joystick along the first axis). Similarly, the operator may move the joystick along a second axis perpendicular to the first axis to provide an operator request that a second boom element (e.g., the stick boom 42) is desirably rotated in a first direction (specified by the direction of joystick movement along the second axis) at a certain angular speed (indicated by displacement of the joystick along the second axis).

The above-described control approach (wherein an operator issues command directly setting the angular velocities of the boom elements 40, 42, 44) may readily enable an operator to control the boom assembly 26 such that the aggregate or cumulative movement of the boom elements 40, 42, 44 results in desired and precise felling head movements. In practice, however, the above-described control approach may be non-intuitive in some cases, particularly for those operators having lower skill or experience levels. The end effector control approaches disclosed herein (in at least some instances) receive the operator requests for boom assembly movement as requests for linear motion or straight line movement of the end effector. Advantageously, such control approaches (referred to herein as an “X-Y end effector control approaches”) may greatly enhance the ease and accuracy with which many work vehicle operators are able to control end effector movement. Accordingly, the following will primarily describe the gyroscope boom assembly control method as implemented utilizing such an X-Y end effector control approach. It is emphasized, however, that such an X-Y end effector control approach need not be employed in all embodiments of the below-described gyroscope boom assembly control method.

In one example of an X-Y end effector control approach, movement of the boom assembly 26 is controlled by receiving operator requests via a bidirectional joystick for linear movement of the felling head 28 (or the stick pin 48) along two substantially perpendicular axes, which extend within the primary boom assembly movement plane 60 (FIG. 2). FIG. 3 illustrates an example of such a bidirectional joystick 86, which is movable with respect to a base 88 from a centralized home position (shown) along or about two perpendicular joystick axes 90, 92. The movement of the bidirectional joystick 86 along the joystick axes 90, 92 may control certain aspects the movement of the boom assembly 26 of the feller buncher 20 (FIGS. 1 and 2), as described below. For ease of reference, the joystick axis 90 is referred to below as the “fore-aft joystick axis,” while the joystick axis 92 is referred to as the “lateral joystick axis.” Other input devices, such as an array of buttons 94, may further be provided on or adjacent the bidirectional joystick 86 to control various other operations of the feller buncher 20.

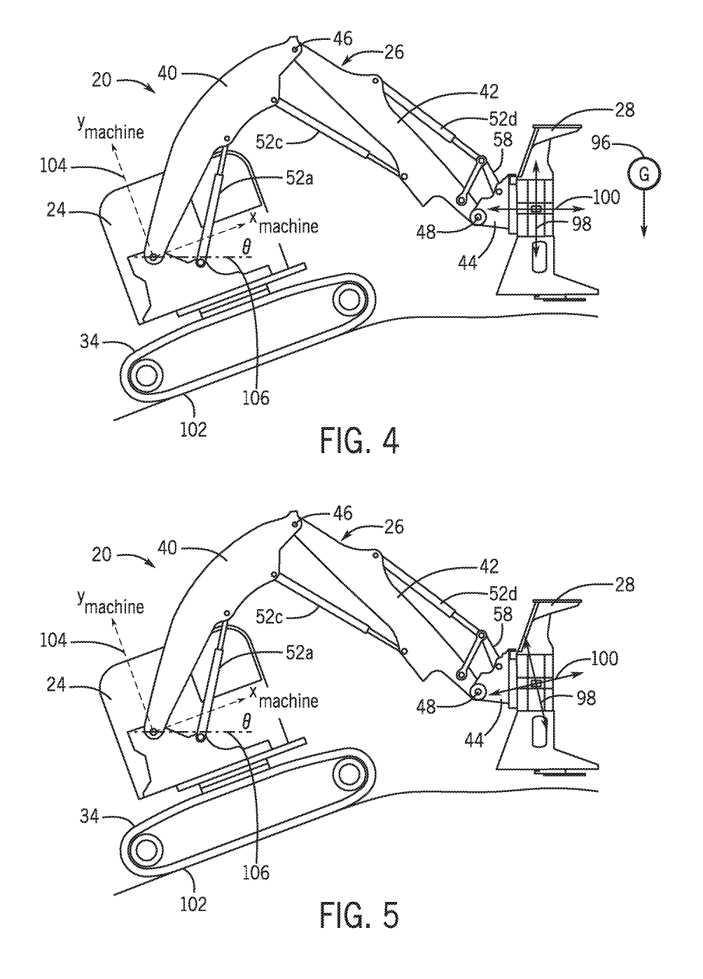

Movement of the joystick 86 may be converted to linear motion or straight line movement of the felling head 28 along a first linear axis (hereafter the “X-axis”) and a second linear axis (hereafter the “Y-axis”), which is substantially perpendicular to the X-axis. The orientation of the X- and Y-axes may vary amongst embodiments in relation to a different frames of reference, which may be preprogrammed and non-adjustable or, instead, freely switched between by an operator as different modes of operation. FIGS. 4 and 5 schematically depict different manners in which the boom assembly 26 may be manipulated to bring about straight line movement of the felling head 28 along linear (X-Y) axes with respect to different frames of reference. Consider first the example scenario shown in FIG. 4 in which linear movement of the felling head 28 is referenced to the direction of gravity (represented by graphic 96). In this case, movement of the joystick 86 along the lateral joystick axis 90 (FIG. 3) results in corresponding movement of the felling head 28 along a vertical axis 98 (FIG. 4) substantially parallel to the direction of gravity. Conversely, movement of the joystick 86 (FIG. 3) along the lateral joystick axis 92 results in corresponding movement of the felling head 28 along a horizontal axis 100 (FIG. 4) perpendicular to the vertical axis 98.

In the scenario depicted in FIG. 5, movement of the felling head 28 is in reference to the orientation of the vehicle frame 24 of the feller buncher 20, as indicated by vehicle reference frame 104. As was previously the case, the feller buncher 20 is operating on an inclined surface 102 such that an angular displacement (θ) is created between the longitudinal axis of the vehicle frame 24 (identified in FIG. 5 as “X_{MACHINE}”) and a horizontal axis represented by dashed line 106. As may be seen, the axes 98, 100 along which the felling head 28 move are orientated in accordance with the vehicle reference frame or coordinate legend 104. In this example, movement of the joystick 86 along the fore-aft joystick axis 92 (FIG. 3) results in movement of the felling head 28 along the axis 100 coaxial with X_{MACHINE} (FIG. 4), while movement of the joystick 86 along the lateral joystick axis 90 (FIG. 3) results in movement of the felling head 28 along an axis 98, which is substantially perpendicular to X_{MACHINE}. In further embodiments, the axes 98, 100 along which linear movement of the felling head 28 occurs may be fixed to another frame of reference, such as a frame of reference of the wrist adapter 44.

To bring about the above-described straight line motion of the felling head 28, the controller 64 (FIG. 1) receives operator requests from the operator interface 38 (again, which may include a joystick, such as the joystick 86 shown in FIG. 4) and subsequently converts the operator requests to target angular velocities of the boom elements 40, 42, 44. The target angular velocities of the boom elements 40, 42, 44 are selected such that, when cumulatively implemented or executed, the desired straight line movement of the felling head 28 is achieved. Additional description of manners in which movement of the boom assembly 26 may be determined and implemented based upon operator requests, whether received as desired linear movement of the felling head 28 or in another format, will now be provided in conjunction with FIGS. 6 and 7. Additionally, further description of manners in which appropriate target angular velocities ((n)ω_{TARGET} may be determined during STEP 112 of the boom assembly control method 108 (FIG. 6) may be found in the following co-pending U.S. patent application, the entirety of which is hereby incorporated by reference: U.S. patent application Ser. No. 14/684,177, entitled “VELOCITY-BASED CONTROL OF END EFFECTOR,” and filed with the United Stated Patent and Trademark Office on Apr. 10, 2015.

FIG. 6 is a flowchart setting-forth a method 108 for controlling boom assembly movement utilizing gyroscopically-detected angular velocity data, which may be carried-out by the gyroscopic boom assembly control system 22 shown in FIG. 1 in an example embodiment of the present disclosure. Gyroscopic boom assembly control method 108 includes a number of process STEPS 110, 112, 114, 116, 118, 120, 122, 124, with STEPS 114, 116, 118 performed as part of a larger PROCESS BLOCK 126. Depending upon the particular manner in which gyroscopic boom assembly control method 108 is implemented, each step generically illustrated in FIG. 6 may entail a single process or multiple sub-processes. Furthermore, the steps illustrated in FIG. 6 and described below are provided by way of non-limiting example only. In alternative embodiments of gyroscopic boom assembly control method 108, additional process steps may be performed, certain steps may be omitted, and/or the illustrated process steps may be performed in alternative sequences.

Gyroscopic boom assembly control method 108 commences at STEP 110 during which operator requests for boom assembly movement are received by controller 64 (FIG. 1). As previously noted, the operator requests are received via the operator interface 38 (FIG. 1) and may directly specify rotational movement (direction and velocity) of one or more boom elements (e.g., the hoist boom 40, the stick boom 42, and/or the wrist adapter 44) in certain implementations. In other implementations, the operator requests may specify a desired movement (e.g., movement along one or more linear axes) of the felling head 28 (or other end effector) supported by the boom assembly 26.

Next, at STEP 112 of gyroscopic boom assembly control method 108, the controller 64 converts the operator requests to target angular velocities of the boom elements 40, 42, 44 of the feller buncher 20. For ease of reference, the target angular velocities of the boom elements 40, 42, 44 are also collectively referred to as “(n)ω_{TARGET}” below, with the prefix “(n)” indicating that, for a given operator request or command received via the operator interface 38, one or more target angular velocities for the boom elements 40, 42, 44 may be determined. For example, an operator request to move the felling head 28 along a straight line in a forward direction may be converted to target angular velocities (ω_{TARGET}) for each of the hoist boom 40, the stick boom 42, and the wrist adapter 44. In contrast, an operator request to rotate the felling head 28 about the stick pin 48, while the hoist boom 40 and the stick boom 42 remain stationary may be converted to a single target angular velocity for the wrist adapter 44, while the target angular velocities of the hoist boom 40 and the stick boom 42 are set at a zero value by default.

In embodiments wherein the operator requests specify desired rotational movements of the boom elements 40, 42, 44, the operator requests may be converted to corresponding target angular velocities ((n)ω_{TARGET}) utilizing a suitable function or formula during STEP 112 of the gyroscopic boom assembly control method 108 (FIG. 6). For example, in an embodiment wherein the operator request is received from the operator interface 38 as an electrical signal indicative of a joystick position, the controller 64 may convert the joystick position to corresponding target angular velocities ((n)ω_{TARGET}) utilizing a suitable logic tool, such as a multidimensional lookup table. Comparatively, in embodiments wherein the operator requests instead specify a desired (e.g., straight line) movement of the felling head 28 (or other end effector), additional information may be gathered and calculations performed by the controller 64 to determine the target angular velocities ((n)ω_{TARGET}) required to bring about the desired linear movement of the felling head 28. More specifically, the respective angular orientations of the hoist boom 40 and the stick boom 42 within the boom assembly movement plane 60 (FIG. 2) may be estimated or approximated in arriving at a set of (n)ω_{TARGET} values appropriate to achieve the desired or requested straight line motion of the felling head 28.

During STEP 112 of the gyroscopic boom assembly control method 108 (FIG. 6), the controller 64 (FIG. 1) may determine the respective current orientations of the boom elements 40, 42, 44 utilizing data provided by the boom assembly orientation sensors 74. In embodiments wherein the orientation sensors 74 include MEMS accelerometers, such as MEMS accelerometers 74(a)-(c) shown in FIG. 2, the controller 64 may determine the current orientations (herein “(n)α_{CURRENT}”) of the boom elements 40, 42, 44 utilizing the acceleration data provided by the accelerometers 74(a)-(c) and filtering for gravity-induced acceleration. Once known or estimated, the current angular orientations ((n)α_{CURRENT}) of the boom elements 40, 42, 44 may be considered in converting newly-received operator requests to the target angular velocities of the hoist boom 40 and the stick boom 42. In one implementation, this is accomplished by first converting α_{CURRENT} for the hoist boom 40 and the stick boom 42 to a spatial position of the stick pin 48 relative to the vehicle frame 24. For example, the stick pin position may be expressed as horizontal and vertical coordinates within the boom assembly movement plane 60 (FIG. 2). The controller 64 may then convert the operator request to target angular velocities ((n)ω_{TARGET}) of the hoist boom 40 and the stick boom 42 utilizing a multidimensional lookup table or other function correlating operator-requested linear end effector movement to a range of stick pin positions. In contrast, the angular velocity of the wrist adapter 44 appropriate to achieve a desired straight line movement of the felling head 28 will typically have little to no variance in conjunction with the current angular orientations of the boom elements 40, 42, 44. Thus, in an embedment, the target angular velocity for the wrist adapter 44 may be determined independently of (n)α_{CURRENT} by directly converting a corresponding to operator request for wrist adapter movement.

Advancing to PROCESS BLOCK 126 of the gyroscopic boom assembly control method 108 (FIG. 6), flow rate adjustments (or other actuator commands) are next determined as a function of the target angular velocities ((n)ω_{TARGET}). The angular velocity data supplied by the MEMS gyroscopes 72 may or may not be considered during PROCESS BLOCK 126. For example, in certain embodiments, the flow rate adjustments may be determined during PROCESS BLOCK 126 without considering angular velocity data provided by the MEMS gyroscopes 72, in which case the angular velocity data may be considered during a subsequently-performed gyroscope feedback control algorithm, as described more fully below in conjunction with FIG. 7. Alternatively, as indicated in FIG. 6, the angular velocity data provided by the MEMS gyroscopes 72 may be considered in determining the appropriate flow rate adjustments to transmit to the boom assembly actuators. In this regard, the MEMS gyroscopes 72 may be utilized to measure the current angular velocities of the boom elements 40, 42, 44 ((n)ω_{CURRENT}) at STEP 114 of the gyroscopic boom assembly control method 108. Any error differentials (herein “(n)ω_{Δ}”) between the currently-detected angular velocities of the boom elements 40, 42, 44 ((n)ω_{CURRENT}) and the previously-established target angular velocities ((n)ω_{TARGET}) may then be calculated (STEP 116), and corresponding flow rate adjustment may be determined based, at least in part, on the calculated error differentials ((n)ω_{Δ}) during STEP 118 of the control method 108.

In certain embodiments, additional parameters may be considered when converting (n)ω_{Δ} to flow rate adjustments during STEP 118 of the boom assembly control method 108. For example, in an embodiment, a mathematical model may be utilized to determine the appropriate flow rate adjustments (or other commands) to achieve the target angular velocities ((n)ω_{TARGET}) of the boom elements 40, 42, 44 and, particularly, of the hoist boom 40 and the stick boom 42. Such a mathematical model may be recalled from the memory 66 (FIG. 1) when needed and may consider various different parameters influencing the operation of the hydraulic cylinders 52. For example, the mathematical model may consider ambient temperature (as effecting hydraulic fluid viscosity), inefficiencies of the hydraulic system (e.g., hydraulic fluid leakage rates), friction coefficients, and other such factors. In certain embodiments, the mathematical model may be adaptive such that one or more of the above-listed parameters varies over time. For example, parameters relating to hydraulic fluid leakage rates or friction coefficients may be adjusted based upon sensor data or as the service hours accumulated by the feller buncher 20 (or other work vehicle) gradually increase.

After determining the appropriate flow rate adjustments at PROCESS BLOCK 126, corresponding flow rate adjustment command signals are transmitted to the boom assembly actuators (e.g., flow control valves 54 in FIG. 1) at STEP 120 of the gyroscopic boom assembly control method 108. In certain embodiments, the gyroscopic boom assembly control method 108 may conclude at this juncture this process. In such embodiments, the gyroscopic boom assembly control method 108 may proceed directly to STEP 124 and await the receipt of new operator requests. Alternatively, as indicated in FIG. 6 at STEP 122, a gyroscope feedback control algorithm may be performed repeatedly until new operator requests are received, as determined at STEP 124. When performed, the feedback control algorithm may be implemented utilizing various different types of proportional-integral-derivative (PID) control schemes, which may be closed loop (non-adaptive) or open loop (adaptive). An example of one such feedback control algorithm that may be performed during STEP 122 of the gyroscopic boom assembly control method 108 will now be described in conjunction with FIG. 7.

FIG. 7 sets-forth a gyroscopic feedback control algorithm 128, which may be performed during STEP 122 of the above-described control method 108 (FIG. 6) in an example embodiment of the present disclosure. After a present iteration of the gyroscopic feedback control algorithm 128 has commenced (STEP 130), the current angular velocities of the boom elements 40, 42, 44 ((n)ω_{CURRENT}) are measured utilizing the MEMS gyroscope 72 (STEP 132). The controller 64 then calculates any error differentials ((n)ω_{Δ}) between the current angular velocities ((n)ω_{CURRENT}) and the target angular velocities ((n)ω_{TARGET}) of the boom elements 40, 42, 44 (STEP 134). Next, during STEP 136, the controller 64 compares the calculated error differentials ((n)ω_{Δ}) to maximum acceptable thresholds. The maximum acceptable thresholds may be pre-established static values stored in the memory 66 or, instead, dynamic values varied in accordance with operator input commands or operational parameters of the feller buncher 20. If the error differentials ((n)ω_{Δ}) do not exceed the acceptable threshold values, the controller 64 proceeds to STEP 142 and the gyroscopic feedback control algorithm 128 concludes.

If, during STEP 126, instead determining that one or more of the error differentials ((n)ω_{Δ}) surpass the acceptable threshold values, the controller 64 next establishes corrective flow rate adjustments for the actuator or actuators (e.g., hydraulic cylinders 52) corresponding to those boom elements 40, 42, 44 exceeding the threshold values (STEP 138). The corrective flow rate adjustments may be determined in a manner essentially analogous to that described above in conjunction with STEP 118 of the gyroscopic boom assembly control method 108. For example, during STEP 138, the controller 64 may establish the corrective flow rate adjustments utilizing a logic function, such as a multidimensional lookup table correlating (n)ω_{Δ} values to a range of flow rate adjustment and possibly other factors (e.g., boom element orientations). Alternatively, the controller 64 may establish the corrective flow rate adjustments or a mathematical model similar or identical to that previously described. The controller 64 then transmits the corrective flow rate adjustments to the appropriate flow control valves 54 (STEP 140). After transmission of the corrective flow rate adjustments, the controller 64 advances to STEP 142 and present iteration of the gyroscopic feedback control algorithm 128 concludes. The controller 64 may then preform additional iterations of the gyroscopic feedback control algorithm 128 until new operator requests or commands are received, as previously described in conjunction with STEP 124 of the gyroscopic boom assembly control method 108 (FIG. 6).

There has thus been provided multiple example embodiments of a gyroscopic boom assembly control system and method, which utilize an array of MEMS gyroscopes to monitor the angular velocities of multiple boom elements, such as the hoist boom and the stick boom of a feller buncher or other work vehicle. During operation, the gyroscopic boom assembly control system receives operator requests specifying desired movements of the boom elements, such as a desired linear movement of the end effector. The boom assembly control system then converts the operator requests to target angular velocities of boom elements, and then transmits appropriate command signals to actuators included within the boom assembly to implement the target angular velocities. In certain embodiments, the angular velocity measurements gathered by the gyroscope array may be considered prior to issuing commands to the boom assembly actuators utilizing a feed-forward control approach. Additionally or alternatively, the angular velocity measurements supplied by the gyroscopes may be considered after issuance of the actuator commands in evaluating and reducing or eliminating any calculated error differentials between the target angular velocities and the measured angular velocities of the boom elements. In this manner, the gyroscopically-detected angular velocity data may be utilized to determine required changes in valve flow to maintain desired (e.g., linear) movements of a felling head (or other end effector) and, in certain embodiments, a desired angular velocity of a wrist adapter.

As will be appreciated by one skilled in the art, certain aspects of the disclosed subject matter may be embodied as a method, system (e.g., a work vehicle control system included in a work vehicle), or computer program product. Accordingly, certain embodiments may be implemented entirely as hardware, entirely as software (including firmware, resident software, micro-code, etc.) or as a combination of software and hardware (and other) aspects. Furthermore, certain embodiments may take the form of a computer program product on a computer-usable storage medium having computer-usable program code embodied in the medium.

Any suitable computer usable or computer readable medium may be utilized. The computer usable medium may be a computer readable signal medium or a computer readable storage medium. A computer-usable, or computer-readable, storage medium (including a storage device associated with a computing device or client electronic device) may be, for example, but is not limited to, an electronic, magnetic, optical, electromagnetic, infrared, or semiconductor system, apparatus, or device, or any suitable combination of the foregoing. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device. In the context of this document, a computer-usable, or computer-readable, storage medium may be any tangible medium that may contain, or store a program for use by or in connection with the instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be non-transitory and may be any computer readable medium that is not a computer readable storage medium and that may communicate, propagate, or transport a program for use by or in connection with an instruction execution system, apparatus, or device.

Aspects of certain embodiments are described herein may be described with reference to flowchart illustrations and/or block diagrams of methods, apparatus (systems) and computer program products according to embodiments of the invention. It will be understood that each block of any such flowchart illustrations and/or block diagrams, and combinations of blocks in such flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

Any flowchart and block diagrams in the figures, or similar discussion above, may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block (or otherwise described herein) may occur out of the order noted in the figures. For example, two blocks shown in succession (or two operations described in succession) may, in fact, be executed substantially concurrently, or the blocks (or operations) may sometimes be executed in the reverse order, depending upon the functionality involved. It will also be noted that each block of any block diagram and/or flowchart illustration, and combinations of blocks in any block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. Explicitly referenced embodiments herein were chosen and described in order to best explain the principles of the disclosure and their practical application, and to enable others of ordinary skill in the art to understand the disclosure and recognize many alternatives, modifications, and variations on the described example(s). Accordingly, various embodiments and implementations other than those explicitly described are within the scope of the following claims.

What is claimed is:

1. A work vehicle, comprising:
an operator interface;
a boom assembly, including:
a first boom element rotatable about a first pivot joint; and
a first actuator coupled to the first boom element and controllable to rotate the first boom element about the first pivot joint;
a first gyroscope mounted to the boom assembly; and
a controller coupled to the operator interface, to the first actuator, and to the first gyroscope, the controller configured to:
determine a target angular velocity for the first boom element from an operator request received via the operator interface; and
selectively command the first actuator to adjust rotation of the first boom element based, at least in part, on the target angular velocity and a current angular velocity of the first boom element sensed by the first gyroscope.

2. The work vehicle of claim 1, wherein the controller is further configured to calculate an error differential between the target angular velocity and the current angular velocity of the first boom element; and
wherein the controller selectively commands the first actuator to adjust rotation of the first boom element based, at least in part, on the calculated error differential.

3. The work vehicle of claim 2, further comprising a sensor coupled to the boom assembly and providing data to the controller indicative of a current orientation of the first boom element;
wherein the controller configured to selectively command the first actuator to adjust rotation of the first boom element as a function of the current orientation of the first boom element and the calculated error differential.

4. The work vehicle of claim 3, wherein the sensor comprises an accelerometer mounted to the first boom element.

5. The work vehicle of claim 4, further comprising an inertial measurement unit mounted to the first boom element;
wherein the inertial measurement unit containing the first gyroscope and the first gyroscope.

6. The work vehicle of claim 1, wherein, in selectively commanding the first actuator to adjust rotation of the first boom element, the controller is configured to:
compare the calculated error differential to a maximum acceptable threshold; and
issue a corrective command to the first actuator when the calculated error differential exceeds the maximum acceptable threshold.

7. The work vehicle of claim 6, wherein the controller is further configured to repeatedly perform the steps of converting, comparing, and issuing until a new operator request is received via the operator interface.

8. The work vehicle of claim 1, further comprising:
a vehicle frame;
an end effector mounted to the vehicle frame by the boom assembly;
wherein the operator interface provides the operator request as a requested linear movement of the end effector; and
wherein the controller is configured to convert the requested linear movement of the end effector to the target angular velocities of the first boom element.

9. The work vehicle of claim 1, further comprising:
a vehicle frame to which the first boom element is pivotally mounted at the first pivot joint;
a second boom element included in the boom assembly pivotally joined to the first boom element at a second pivot joint;
a second gyroscope mounted to the second boom element; and
a second actuator further included in the boom assembly, coupled to the second boom element, and controllable to rotate the second boom element about the second pivot joint.

10. The work vehicle of claim 9, wherein the controller is further configured to:
convert the operator request to a target angular velocity for the second boom element; and
selectively command the second actuator to adjust rotation of the second boom element based, at least in part, on the target angular velocity and a current angular velocity of the second boom element sensed by the second gyroscope.

11. The work vehicle of claim 9, wherein the first gyroscope is mounted to the first boom element at a location closer to the second pivot joint than to the first pivot joint.

12. The work vehicle of claim 9, further comprising:
a felling head;
a wrist adapter included in the boom assembly and rotatably coupling the second boom element to the felling head; and
a third gyroscope coupled to the controller and mounted to the wrist adapter.

13. A work vehicle, comprising:
a vehicle frame;
an end effector;
a boom assembly mounting the end effector to the vehicle frame, the boom assembly including:
a hoist boom joined to the vehicle frame at a first pivot joint;
a stick boom coupled between the vehicle frame and the end effector, the stick boom joined to the hoist boom substantially opposite the vehicle frame at a second pivot joint;
a first actuator coupled to the hoist boom and controllable to rotate the hoist boom about the first pivot joint; and
a second actuator coupled to the stick boom and controllable to rotate the stick boom about the second pivot joint;
first and second gyroscopes mounted to the hoist boom and to the stick boom, respectively; and
a controller operably coupled to the first and second actuators and to the first and second gyroscopes, the controller configured to command the first and second actuators to selectively rotate the hoist boom and the stick boom based, in part, on angular velocity data provided by the first and second gyroscopes.

14. The work vehicle of claim 1,3 further comprising an operator interface coupled to the controller;
wherein the controller is configured to:
receive operator requests for movement of the boom assembly via the operator interface;
convert the operator requests to target angular velocities for the hoist boom and the stick boom; and
command the first and second actuators to selectively adjust rotation of the hoist boom and the stick boom in accordance with the target angular velocities.

15. The work vehicle of claim 13, wherein the operator interface provides the operator requests as a requested linear movement of end effector; and
wherein the controller converts the requested linear movement of the end effector to the target angular velocities of the hoist boom and the stick boom.

16. A method for controlling boom assembly movement, the method comprising:
receiving operator requests for movement of a boom assembly;
converting the operator requests to target angular velocities for multiple boom elements ((n)ω_{TARGET}) included in the boom assembly;
transmitting command signals to actuators further included in the boom assembly to rotate the multiple boom elements in accordance with (n)ω_{TARGET};
after transmitting the command signals, measuring current angular velocities of the multiple boom elements ((n)ω_{CURRENT}) utilizing gyroscopes mounted to the boom assembly;
calculating error differentials between (n)ω_{TARGET} and (n)ω_{CURRENT}; and
transmitting further command signals to the actuators to reduce any error differentials exceeding one or more maximum acceptable thresholds.

17. The method of claim 16, wherein receiving the operator requests comprises receiving the operator requests as operator requests for linear movement of an end effector mounted to the boom assembly; and
wherein converting the operator requests comprises converting the operator requests for linear movement of the end effector to target angular velocities for the multiple boom elements.

18. The method of claim 17, further comprising estimating current angular orientations ((n)α_{CURRENT}) of the multiple boom elements based, at least in part, on acceleration data provided by accelerometers mounted to the boom assembly;
wherein converting comprises converting the operator requests for linear movement of the end effector to target angular velocities for the multiple boom elements utilizing (n)α_{CURRENT}.

19. The method of claim 18, wherein estimating the current angular orientations ((n)α_{CURRENT}) of the multiple boom elements comprises approximating the position of a stick pin, which pivotally joins the boom assembly to a felling head, relative to a frame of a work vehicle to which the boom assembly is mounted.

20. The method of claim 18, further comprising determining the command signals based, at least in part, on one or more error differentials between (n)ω_{TARGET} and the current angular velocities of the multiple boom elements, as measured prior to transmitting the command signals.
